(19) United States
(12) Patent Application Publication
(10) Pub. No.: US 2019/0057105 A1
(43) Pub. Date: Feb. 21, 2019

(54) SYSTEM, METHOD, AND PROGRAM PRODUCT FOR IMPLEMENTING AND CREATING, READING, UPDATING AND DELETING JSF PAGES IN CONTENT MANAGEMENT SYSTEM

(71) Applicant: Singareddy Information Technologies, Inc., Lawrenceviille, GA (US)

(72) Inventor: Ravindra Reddy Singareddy., Lawrenceville, GA (US)

(73) Assignee: Singareddy Information Technologies, Inc., Lawrenceville, GA (US)

(21) Appl. No.: 15/693,453

(22) Filed: Aug. 31, 2017

Related U.S. Application Data
(63) Continuation-in-part of application No. 15/679,092, filed on Aug. 16, 2017.

(51) Int. Cl. G06F 17/30; G06F 9/54

(52) U.S. Cl. CPC G06F 17/3089; G06F 9/547

(57) ABSTRACT

In Java Server Faces based Enterprise applications, java and jsf resources are compiled and deployed in applications servers. These Java Server Faces (jsf) pages are static in web archives. These static JSF pages during runtime converted to HTML page by JSF framework. In current existing JSF frameworks or in enterprise applications, it is not possible to create, update and delete JSF to web server during runtime. Using portal technologies, with JSF portlet bridge, it is possible to add JSF portlets to portal web applications, with predefined JSF portlet. In the web applications without any portal server, it is not possible to add Java Server Faces (JSF) page during runtime to web server. This research invention attempts to add, modify and delete JSF pages to and from web server during runtime, without stop and starting web server. This research invention will play a great role in multi-tenant cloud based and on-premise enterprise applications.

### CROSS REFERENCE TO RELATED APPLICATION

This application is a continuation-in-part to U.S. non provisional application Ser. No. 15/679,092, the disclosure in it's entirety is referenced herein.

### FIELD OF THE INVENTION

The disclosed embodiments relate generally to storing, retrieving and rendering content from Content Management System (CMS) and methods, and in particular to Apache Sling Web Framework for create, read, update and deleting Java Server Faces (JSF) for large scale enterprise applications during runtime without stopping and starting webserver or application server.

### BACKGROUND OF THE INVENTION

Java Content Repository Technology API version 1.0 (JSR 170) and version 2.0 (JSR 283) specifications developed by Java Community Process are the building blocks of JCR based content repositories.

Apache Jackrabbit is an open source content repository which is a reference implementation of JSR 170 for the Java platform and donated by Day Software. Apache Jackrabbit is a reference implementation of JSR 170, specified within the Java Community Process.

Apache Oak evolved from Apache Jackrabbit with the goal of improving the performance and scalability of JSR 170 applications and addressing the mobile and cloud deployment solutions.

Apache Sling is a Representational State Transfer (REST) or RESTful web services web framework for providing interoperability between computer systems on the Internet. This Sling framework uses Apache Jackrabbit and Oak as content repository to manage content. Apache Sling is powered by Apache Felix Open Service Gateway Initiative (OSGi) Java framework for developing and deploying modular software programs and libraries.

Day Software which is main force behind building Apache Jackrabbit, Oak and Sling is acquired by Adobe. Now these technological stacks are part of the Adobe Experience Manager (AEM).

There are several Content Management System implementations utilizing Apache Jackrabbit as JCR and a few of these are Apache Sling, Hippo CMS, eXO JCR, Jahia, LogicalDOC, Magnolia CMS, Open KM, Sakai Project and Adobe AEM.

Adobe Experience Manager (Adobe AEM) content management system is based on Apache Sling Web Framework. Apache Sling Web Framework is built on Sling Servlet and works using Java Server Pages and HTL (HTML Template Language or Slightly) client-side scripting framework using restful web services framework. Evolving technological requirements from cloud environments mandate adopting Apache Sling Web Framework to deploy Java J2EE specifications.

Apache Sling Web Framework is designed with limited security features; hence it cannot be utilized in Java J2EE enterprise Web Framework without implementing a secure framework.

Java Server Pages (“JSP”) is a Java View Technology that allows the user to write template text in client-side languages. Page flow and output can be controlled by the user utilizing pieces of Java code backing taglibs supported by JSP. Backend data can be accessed by Expression Language (“EL”) which is also supported by JSP. JSTL (JSP Standard Tag Library) is a JSP based standard tag library that offers tags to control the flow in the JSP page, date/number formatting and internationalization facilities and several utilities EL functions.

When a JSP is requested for the first time or when the web app starts up, the servlet container compiles the JSP into a class extending HttpServlet. Source code generated therefrom can be found in the server's work directory. On a JSP request, outputs are displayed in the web browser by executing the compiled JSP class and sending the generated output through the web server over a network to the client side.

Contrarily, in Apache Sling Web Framework, JSP page is added to the Content Management System. The request will be handled by the Sling Servlet if the user requests for jsp page from the content Management System. The Sling Servlet will convert this jsp page into HTML/CSS/JS content, which in turn displays it in the web browser.

To render content and embed business logic as taglibs on the client side, Apache Sling Web Framework utilizes Java Server Pages (JSP) and HTML Template Language (HTL). This may give limited advantage for adding client scripting but the disadvantage is that results in a complex client-side scripting which is not easy to manage, and ultimately leads to expensive request processing when building web pages with Apache Sling.

Spring Framework is an application framework and inversion of control container for the Java platform. It is not possible to implement Open Source Java/J2EE Spring Framework, Enterprise Java Beans (EJB), Service Oriented Architecture (SOA) and Java Server Faces (JSF) in to Apache Sling Web Framework because Sling Servlet overrides all the HTTP requests.

In this integrated Apache Sling and JSF Web Framework, Java Server Faces are added during runtime to the Apache Sling Content Management System. These added JSF page is coded with jsf tags and which cannot be rendered by the web server without converting into HTML code. These JSF page is parsed and will be created javax.faces.component.UIComponent tree structure. These UIComponent tree structure is encoded to create HTML page for rendering in Web Server.

Apache Sling Web Framework is great tool for saving and retrieving content from JCR. But it cannot be adopted in Java/J2EE enterprise applications to serve on premise and cloud environments.

### SUMMARY

In this research innovation, in addition of Java Server Pages (JSP) view, adding Java Server Faces (JSF) component based MVC framework for Apache Sling Web framework and also adding, modifying and deleting Java Server Faces (JSF) to and from the Apache Sling Content Management System.

A content management system having Apache Sling Web Framework comprises a memory device and a processor. The processor performs the steps of creating, reading, updating and deleting content stored in the memory device. The content management system accepts a framework into a Java EE compliance framework and the framework builds one or more Java EE Architecture applications. Each of the one or more Java EE Architecture applications has functionalities of a plurality of Java EE Standard Services or Java based Spring infrastructure framework tools, but do not any have any specific content management associated with the framework. Each of the one or more Java EE Architecture framework applications can be extended with the content management system functionality in same web or application server using modified Apache Sling Web Framework without affecting existing functionality.

In an embodiment, the Apache Sling Web Framework web archive web deployment descriptor (or WebServlet Specification) Sling Servlet override functionality converted into default servicing servlet means. If no other servlet satisfies that request, Sling Servlet accepts that request in same web or application server to provide additional functionality to the web application framework.

In an embodiment, the Apache Sling Web Framework web archive web deployment descriptor (or WebServlet Specification) in addition to Sling Servlet and can in cooperate one or more other Servlets.

In an embodiment, the modifications to the Apache Sling Web Framework have Java EE compliance.

In an embodiment, the content management system has the ability to Create, Read, Update and Delete operations to Java Server Faces Pages performed on the Content Management System using one or more RESTFul Web Services in single Web or the Application Server.

In an embodiment, the content management system has the ability to Create, Read, Update and Delete operations to Java Server Faces Pages performed on the Content Management System using one or more RESTFul Web Services in single Web or the Application Server through CURL interface.

In an embodiment, the content management system has the ability to Create, Read, Update and Delete operations to Java Server Faces Pages performed on the Content Management System using one or more RESTFul Web Services in single Web or the Application Server through Http Client interface.

In an embodiment, the content management system has the ability to Create, Read, Update and Delete operations to Java Server Faces Pages performed on the Content Management System using one or more RESTFul Web Services in single Web or the Application Server through Web interface.

In an embodiment, the modifications to the Apache Sling Web Framework have Java EE compliance and to view the content management system files using WebDav interface in single Web or the Application Server.

In an embodiment, the modifications to the Apache Sling Web Framework to have Java EE compliance and to view the content management system using Felix OSGI console in single Web or the Application Server.

In an embodiment, the modifications to the Apache Sling Web Framework to have Java EE compliance and supporting OSGi framework specifications using Sling Management Console.

In an embodiment, the modifications to the Apache Sling Web Framework have Java EE compliance and having Create, Read, Update and Delete operations to Java Server Faces Pages performed on the Content Management System using one or more RESTFul Web Services in single Web or the Application Server through CURL interface.

In an embodiment, the modifications to the Apache Sling Web Framework have Java EE compliance and having Create, Read, Update and Delete operations to Java Server Faces Pages performed on the Content Management System using one or more RESTFul Web Services in single Web or the Application Server through Http Client application interface.

In an embodiment, the modifications to the Apache Sling Web Framework have Java EE compliance and having Create, Read, Update and Delete operations to Java Server Faces Pages performed on the Content Management System using one or more RESTFul Web Services in single Web or the Application Server through Web interface.

In an embodiment, the modifications to the Apache Sling Web Framework to have Java EE compliance and to support Open Source Spring Framework in single Web or the Application Server.

In an embodiment, the modifications to the Apache Sling Web Framework to have Java EE compliance selected from the group consisting of; Java EE Standard Services (HTTP, HTTPS, JTA, RMI-IIOP, Java IDL, JDBC API, Java Persistence API (JPA), Java Messaging System (JMS), Java Naming and Directory Interface (JNDI), Java Mail, JavaBeans Activation Framework (JAF), XML Processing (JAXP), Java EE Connector Architecture, Security Services, Web Services, Concurrency Utilities, Batch, Management, Deployment, Interoperability, Product Extensions, Platform Roles and Contracts, in single Web or the Application Server.

In an embodiment, the modifications to the Apache Sling Web Framework have Java EE compliance along with running in Enterprise Java Beans (EJB) container in the same Application Server.

In an embodiment, the modifications to the Apache Sling Web Framework have Java EE compliance along with supporting Service Oriented Architecture (SOA) middleware framework in the same Application Server.

In an embodiment, the modifications to the Apache Sling Web Framework have Java EE compliance along with accessing data from Relational Database in same Web or Application Server.

In an embodiment, the modifications to the Apache Sling Web Framework have Java EE compliance along with no change in JSP, HTL and other scripting supporting functionality for content management system support in the same Web or the Application Server.

In an embodiment, the modifications to the Apache Sling Web Framework have Java EE compliance along with displaying content using Java Server Faces without using JSF bridge or JSF Portlet bridge in the Web or the Application Server.

In an embodiment, the modifications to the Apache Sling Web Framework have Java EE compliance along with a tenant level content management system in same Web or the Application server.

In an embodiment, the modifications to the Apache Sling Web Framework have Java EE compliance and displaying content in any of the Java Server Faces Frameworks in the same Web or the Application server.

### BRIEF DESCRIPTION OF THE DRAWINGS

Various embodiments of the invention are disclosed in the following detailed description and accompanying drawings.

FIG. 1. illustrates Apache Sling wed framework architecture, according to an embodiment of the present invention;

FIG. 2. illustrates Apache Sling web archive directory architecture, according to an embodiment of the present invention;

FIG. 3. illustrates custom JSF web archive directory structure, according to an embodiment of the present invention;

FIG. 4. illustrates custom JSF and Apache Sling web archive directory structure, according to an embodiment of the present invention;

FIG. 5. illustrates Java server faces life cycle, according to an embodiment of the present invention;

FIG. 6A. illustrates a description of Sling JSF Filter, according to an embodiment of the present invention;

FIG. 6B. illustrates a description of Sling JSF Filter, according to an embodiment of the present invention;

FIG. 7. illustrates a description of web deployment descriptor, according to an embodiment of the present invention;

FIG. 8A. illustrates a process flow for Sling servlet path info in service method, according to an embodiment of the present invention;

FIG. 8B. illustrates a process flow for Sling servlet path info in service method, according to an embodiment of the present invention;

FIG. 9A. illustrates a process flow for Sling servlet request URI in service method, according to an embodiment of the present invention;

FIG. 9B. illustrates a process flow for Sling servlet request URI in service method, according to an embodiment of the present invention;

FIG. 10A. illustrates a process flow for Sling servlet request URL in service method, according to an embodiment of the present invention;

FIG. 10B. illustrates a process flow for Sling servlet request URL in service method, according to an embodiment of the present invention;

FIG. 11. illustrates the incorporation of JSF servlet and Sling servlet into Apache Sling web application, according to an embodiment of the present invention; and

FIG. 12. illustrates the converting Java Server Faces (JSF) file from Content Management System into displayable HTML code.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

Component based Java Server Faces or ASP.net frameworks are used for building complex enterprise applications. For most of the enterprise applications incorporation of a content management system is a necessity. In cooperating commercial grade content management systems Alfresco, IBM Web Content Management, Oracle Web Center or Adobe Experience Manager is not an easier task when servicing enterprise applications.

In this research effort JSF based enterprise content management system are built on Apache Sling Web Framework for storing and retrieving content from the Java Content Repository (JCR). Out of the box Apache Sling Web framework is not a Java/J2EE complaint component framework.

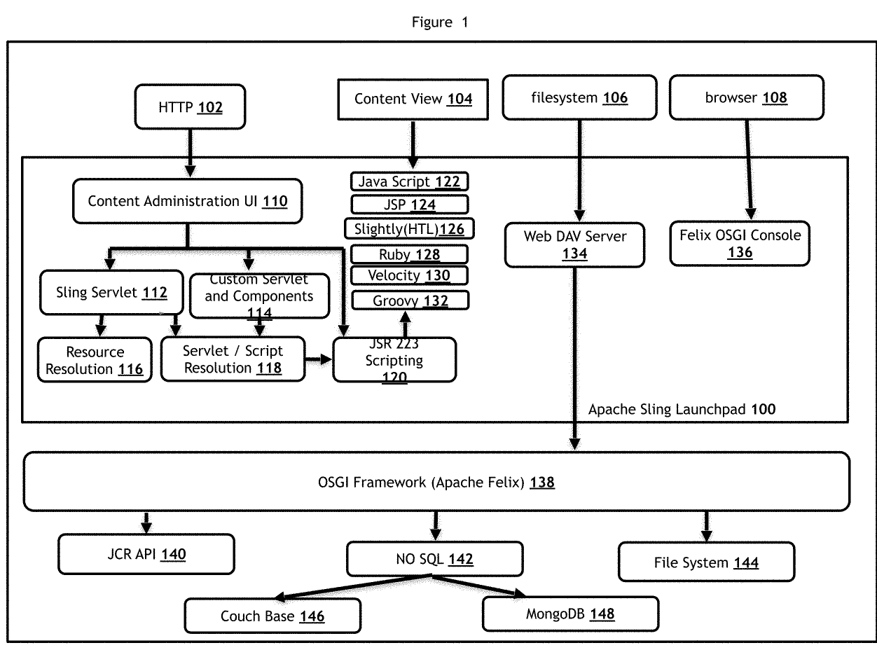

FIG. 1 illustrates existing Apache Sling Web Framework Architecture.

Sling may be launched utilizing the Apache Sling Launchpad 100 as either a standalone application using the Sling Application, or as a Web Application running inside any Servlet API 2.4 or newer Servlet Container. The Felix implementation of the OSGi HttpService specification is used regardless of how Sling is launched. With this, Sling may be launched in two ways. First, as a standalone Java Application, Felix HttpService uses an embedded version of the Jetty servlet container. Second, when launched as a Web Application, the Felix HttpService Bridge is used. Sling may be launched as a standalone Java Application or as a Web Application inside any compliant Servlet Container. Sling internally registers a Servlet with an OSGi HttpService to hide the differences of the launching mechanism.

The Sling Application is a standalone Java Application having just the main class and some glue classes. To update the framework and/or OSGi API libraries from within Sling by updating the system bundle, OSGi framework 136 as well as the OSGi API libraries are packaged as a JAR file and loaded through a custom classloader.

In further reference to FIG. 1, using Http interface 102, the Apache Sling launchpad 100 can be accessed. Content 104 from the JCR can be viewed using scripting mechanisms. JCR Content is represented as in the form of File System 106. Using a Browser 108 and Felix OSGI Console content can be viewed. Using Content Administration UI 110, CRUD (Create, Read, Update and Delete) operations can be performed on the Content.

The Sling Servlet 112 is equally small as the Sling Application. It uses the Felix HttpService bridge as the glue between the servlet container and the OSGi framework.

Custom Servlet and Components 114 are utilized in the following manner. To use the servlets, they must be registered as OSGi services for the javax.servlet.Servlet interface and provide a number of service registration properties. In fact servlets thus registered as OSGi services are mapped into the resource tree by means of a servlet resource provider. This maps the servlets into the resource tree using the service registration properties to build one or more resource paths for the servlet. Scripts and servlets may be handled completely transparently as a result of mapping into a resource tree. In this manner, servlet resolver just looks for a resource matching the resource type and adapts the resource found to javax.jcr.Servlet. Once this occurs, if the resource happens to be provided by a servlet resource provider, the adapter must be the servlet itself. In the case that the resource happens to be a script, the adapter must be a servlet facade internally calling the script language implementation to evaluate the script.

The Resource Resolution 116 is one of the central parts of Sling. Extending from JCR's Everything is Content, Sling assumes Everything is a Resource. Thus, Sling is maintaining a virtual tree of resources, which is a merger of the actual contents in the JCR Repository and resources provided by so called resource providers.

Servlet and Script Resolution 118: Because Sling is a resource tree, scripts are represented as a resource which may be provided within a bundle or apart of the platform file system, rather than being provided as content in a JCR repository. This allows for mapping from the resource to the script path that is easy to understand. Of course, correct language is needed in order to accurately evaluate the script. To address this, Sling utilizes the Resource.adaptTo(Class<Type>) method. If a script language implementation is available for the extension of the script name an adaptor for the script resource can be found, which handles the evaluation of the script.

JSR 120 and Scripting 223 is accomplished by scripting mechanisms used in Apache Sling Web Framework. These may include but are not limited to Java Script 122, JSP 124, HTL (Slightly or HTML Template Language 126, Ruby 128, Velocity 130 and Groovy 132.

Webdav Server Java Content Repository 134 can be accessed through the WebDav. The Apache Felix Web Console 136 is a simple tool to inspect and manage OSGi framework instances from Web Browser.

Apache Felic OSGi Framework 138: The Sling application is built as a series of OSGi bundles and makes heavy use of a number of OSGi core and compendium services.

JCR API Apache Jackrabbit 140 is a complete, and fully compliant implementation of the Content Repository API for Java Technology (JCR) and therefore its primary API is defined by JCR._JCR Content Can be store using File System 144, or NO SQL 142 tools such as Couch Base 144 or MongoDB 146 databases.

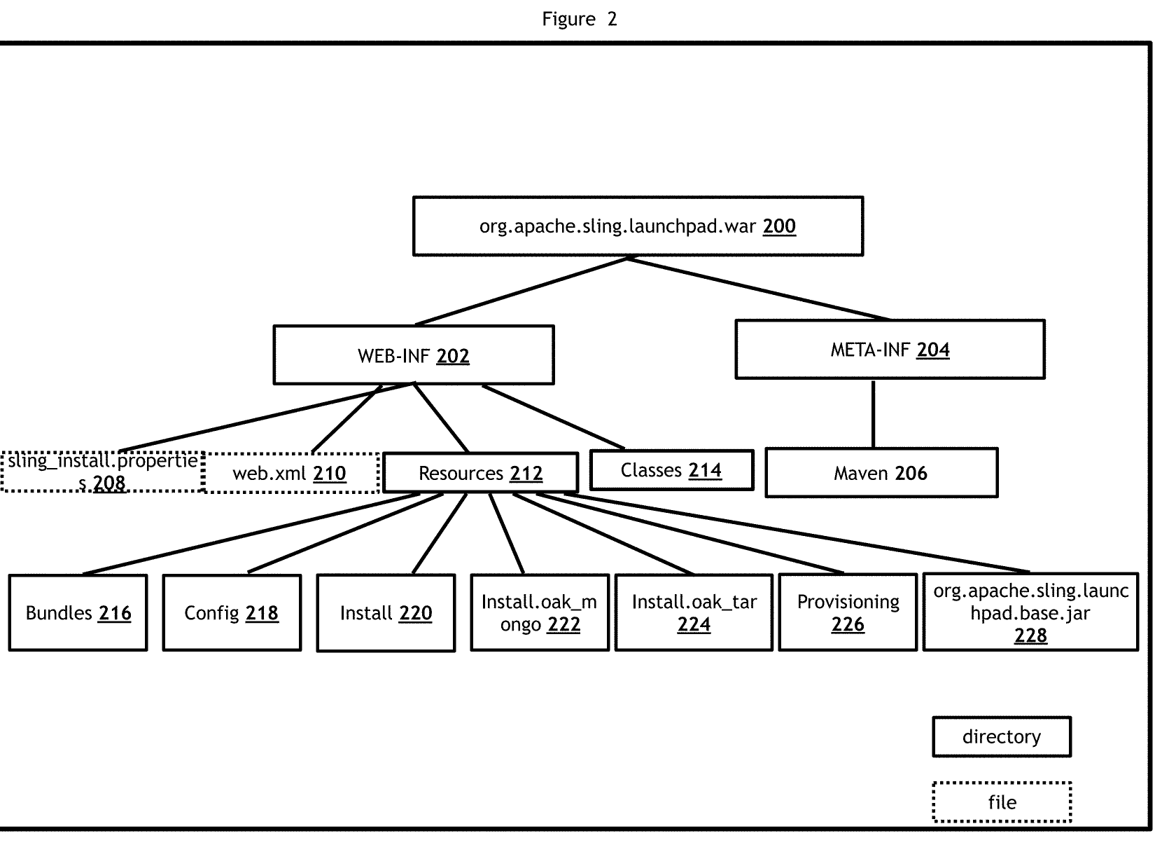

FIG. 2 illustrates an existing Apache Sling web archive (org.apache.sling.launchpad.war) directory structure as known in the arts. The following are components illustrated in FIG. 2.
200 org.apache.sling.launchpad.war—war file
202 WEB-INF—directory
204 META-INF—directory
206 META-INF/maven—directory
208 WEB-INF/sling_install.properties—file
210 WEB-INF/web.xml—file
212 WEB-INF/resources—directory
214 WEB-INF/resources/classes—directory
216 WEB-INF/resources/bundles—directory
218 WEB-INF/resources/config—directory
220 WEB-INF/resources/install—directory
222 WEB-INF/resources/install.oak_mongo—directory
224 WEB-INF/resources/install.oak_tar—directory
226 WEB-INF/resources/provisioning—directory
228 WEB-INF/resources/org.apache.sling.launchpad.base.jar—file

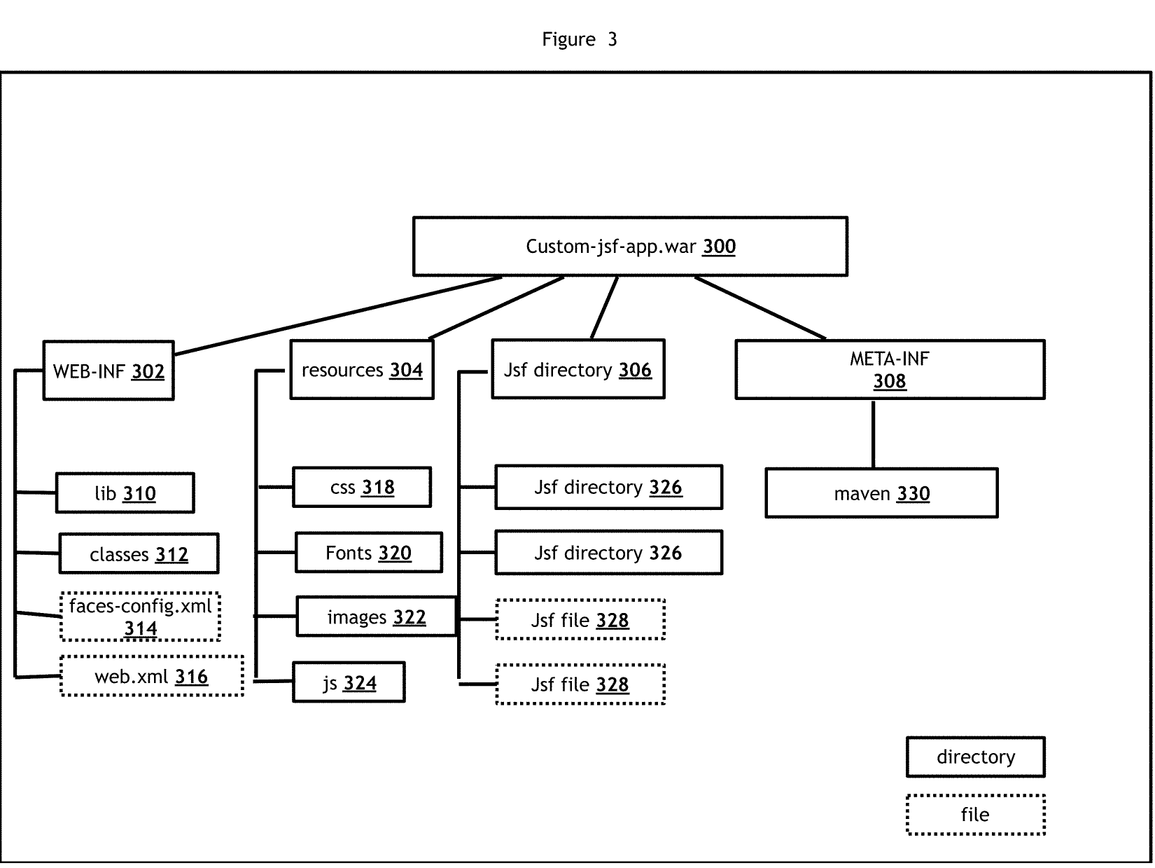

FIG. 3 illustrates custom JSF web archive directory structure as known in the arts. The following are items comprising the JSF web archive directory structure.
300 Custom JSF Application war—war file
302 WEB-INF—directory
304 resources—directory
306 JSF Directory—directory
308 META-INF—directory
310 WEB-INF/lib—directory
312 WEB-INF/classes—directory
314 WEB-INF/faces-config.xml—file
316 WEB-INF/web.xml—file
318 resources/css—directory
320 resources/fonts—directory
322 resources/images—directory
324 resources/js—directory
326 JSF Directory/JSF Directory—directory
328 JSF Directory/JSF—file
330 WEB-INF/maven—directory

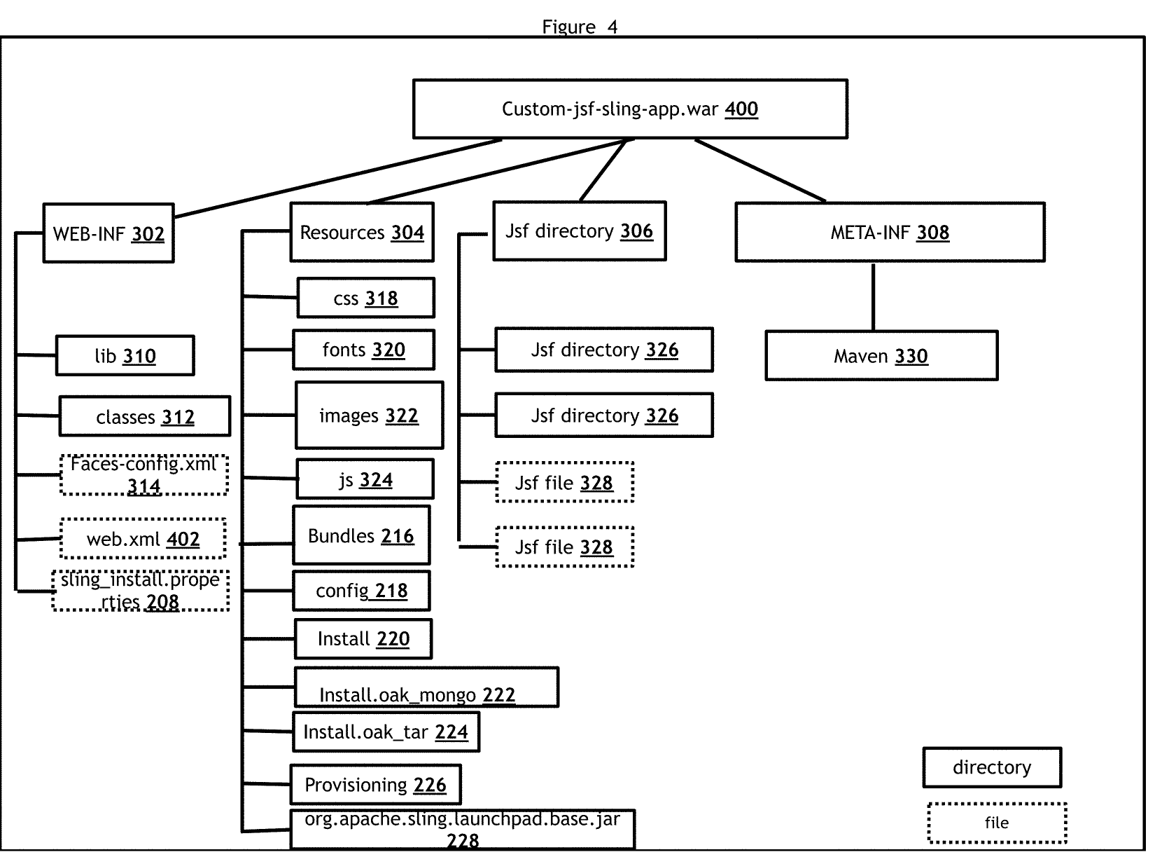

FIG. 4 illustrates custom JSF and Apache Sling web archive directory structure. Apache Sling Web Archive contents are copied to Custom JSF Web Archive as follows:
400 Custom Sling and JSF war—war file
302 WEB-INF—directory
304 resources—directory
306 JSF Directory—directory
308 META-INF—directory
310 WEB-INF/lib—directory
312 WEB-INF/classes—directory
314 WEB-INF/faces-config.xml—file
402 WEB-INF/web.xml—file
208 WEB-INF/sling_install.properties—file
318 resources/css—directory
320 resources/fonts—directory
322 resources/images—directory
324 resources/js—directory
216 resources/bundles—directory
218 resources/config—directory
220 resources/install—directory
222 resources/install.oak_mongo—directory
224 resources/install.oak_tar—directory
226 resources/provisioning—directory
228 resources/org.apache.sling.launchpad.base.jar—file
326 JSF-Directory/JSF Directory—directory
328 JSF-Directory/JSF—file
330 META-INF/maven—directory
   Advantages of Java Server Faces compared to the Java Server Pages

Java Server Faces (“JSF”) is built on the Servlet API as a component based MVC framework. JSF provides taglibs (via components) used in any Java based technology. Facelets namely provides tempting capabilities such as composite components, while JSP offers <jsp:include> for templating. If the user desires to replace a repeated group of components with a single component, they are forced to create custom components with raw Java code.

The Faces Servlet 502 is the sole request-response Controller provided by JSF. The Faces Servlet automates many processes for the user, offering a simpler and less error prone technique. This a JSP or Facelets (XHTML) page for View and a JavaBean class as Model are generated.

### Java Server Faces and Lifecycle

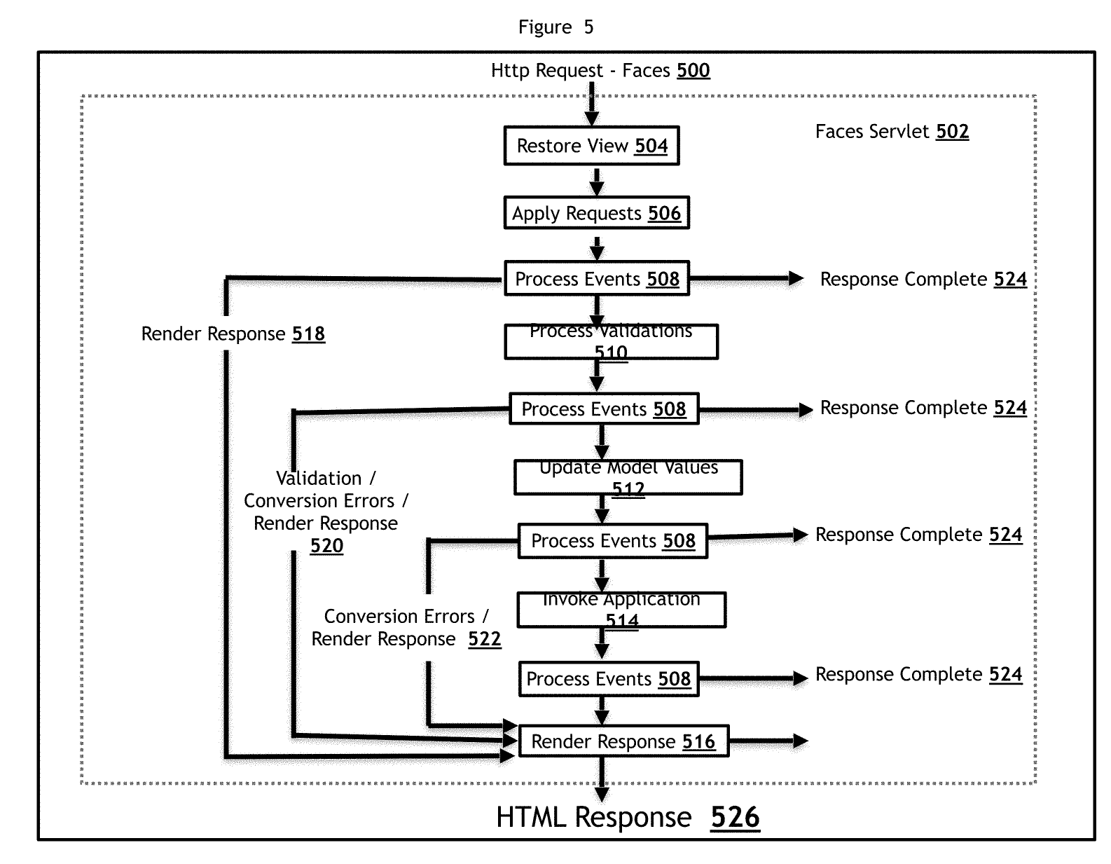

The JavaServer Faces implementation performs all these tasks as a series of steps in the JavaServer Faces request-response lifecycle. FIG. 5 illustrates these steps.

First, a client makes an HTTP request 500 for a page. The server then responds with the page translated to HTML 526.

The lifecycle can be divided into two main phases. The first is execute, subdivided into sub phases, and the second is render. component data must be converted and validated while component events must be handled, and component data propagated in an orderly fashion.

A tree of components, otherwise called a view, is a visual representation of the JavaServer Faces. Faces Servlet 502 builds the view while considering the state saved from a previous submission of the page. The Java Server Faces (implementation performs several tasks, such as validating the data input of components (518, 520, 522) in the view and converting input data to types specified on the server side when the client places a request. Process Events 508, Restore View Phase 504, Apply Request Value Phase 506, Process Validation Phase 510, Update Model Value Phase 512, Invoke Application Phase 514 and Render Response Phases 516 are known in the arts.

Apache Sling Web framework uses Sling Servlet 112 with url-pattern of <url-pattern>/*</url-pattern> in web.xml. Servlet with a url pattern of /* will override all of the other servlets, including all the servlets provided by the servlet container such as default servlet and any other JSP or JSF Servlets.

Even if one added any other Servlet configuration such as Faces Servlet to Apache Sling Web Framework web.xml, it will not be triggered because of the Sling Servlet url pattern of /*. Using this url pattern all JSF Http Requests are overridden by Sling Servlet requests.

On the other hand <url-pattern>/</url-pattern> does not override any other servlet. If a servlet with such url-pattern will invoke when all other Servlet url pattern requests does not match with the registered servlets.

This invention supports a url-pattern of <url-pattern>/</url-pattern> for a Sling Servlet in web.xml and adds Faces Servlet url pattern of <url-pattern>*.xhtml</url-pattern> and <url-pattern>*.jsf</url-pattern>.

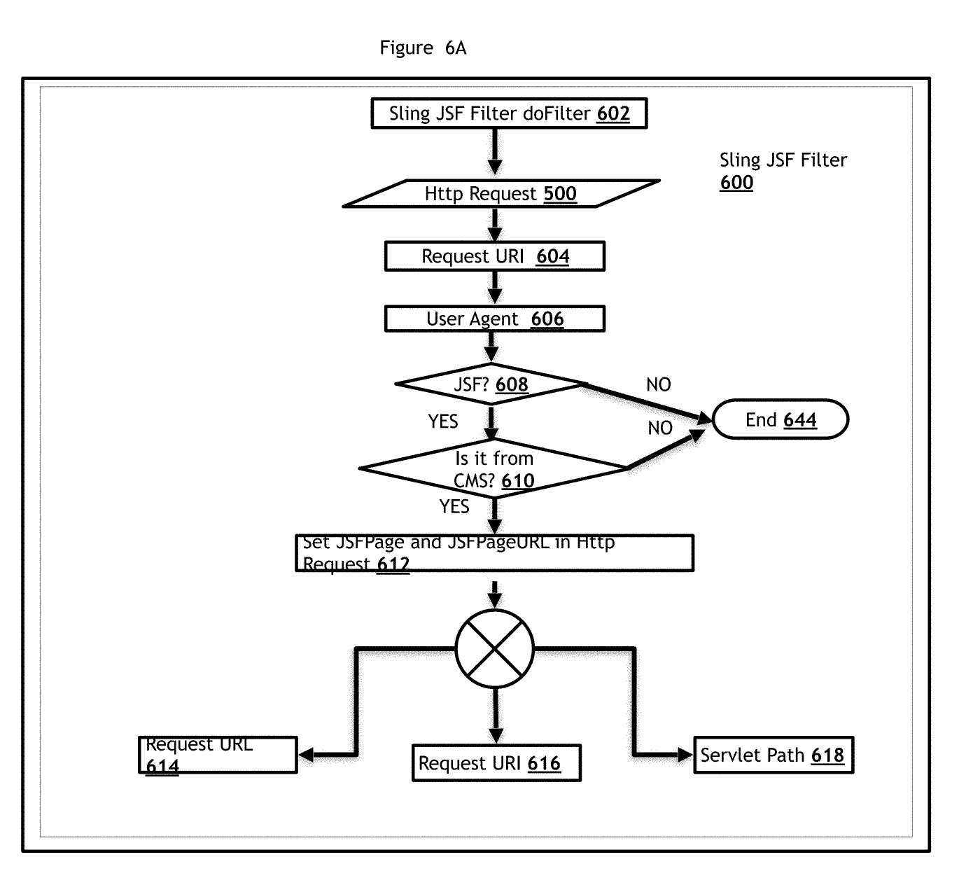

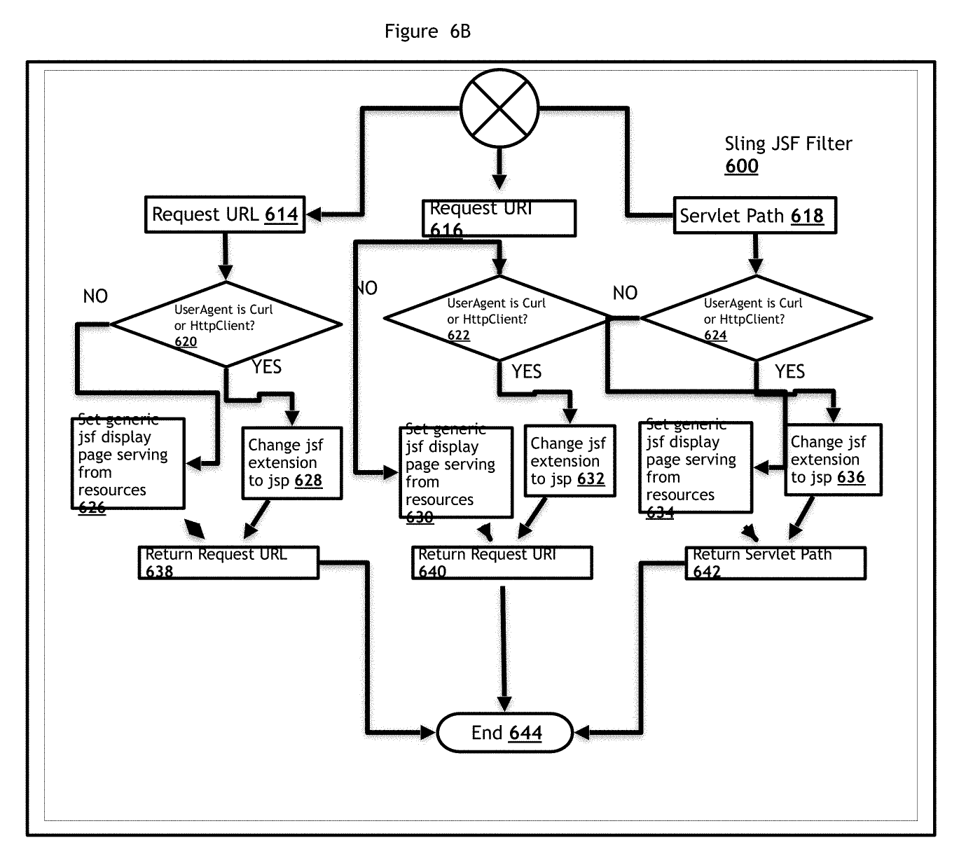

FIG. 6 illustrates the process flow for Sling JSF Filter and which plays a important role in accessing and rendering JSF from Apache Sling Web Framework Content Management System. Sling JSF Filter we will have in built business logic whether this requested JSF is from JSF resources or from the Content Management System. If the user request is from the CURL or from HttpClient based on the User Agent value, system will provide raw content of the JSF file, otherwise if the request is from browser, JSF content will be rendered in HTML format. Sling JSF Filter doFilter method is described below.
602 Sling JSF Filter doFilter Method
500 Http Request
604 Get Request URI from Http Request
606 Get User Agent from Http Request
608 Is the Http Request is JSF file?
   If the Http Request is for JSF file go to 610
   If the Http Request is not for JSF file go to End 632
610 Is this requested JSF is from CMS?
   If the requested JSF is from CMS go to 612
   If the Http Request is not for JSF file go to End 632
612 Set JSFPage and JSFURL in Http Request. After setting these values request can go to 614, 616 or 618
614 Get Request URL from Http Request and go to 620
620 User Request is from Curl or from Http Client?
   If the User Request is not from Curl or from Http Client go to 626
   If the User Request is from Curl or from Http Client go to 628
626 Set generic jsf display page serving from JSF resources and go to 638
628 Change jsf extension to jsp and go to 638
638 Return Request URL and go to 644
616 Get Request URI from Http Request and go to 622
622 User Request is from Curl or from Http Client?
   If the User Request is not from Curl or from Http Client go to 630
   If the User Request is from Curl or from Http Client go to 632
630 Set generic jsf display page serving from JSF resources and go to 640
632 Change jsf extension to jsp and go to 640
640 Return Request URI and go to 644
618 Get Servlet Path from Http Request and go to 624
624 User Request is from Curl or from Http Client?
   If the User Request is not from Curl or from Http Client go to 634
   If the User Request is from Curl or from Http Client go to 636
634 Set generic jsf display page serving from JSF resources and go to 642
636 Change jsf extension to jsp and go to 642
642 Return Servlet Path and go to 644
644 End processes

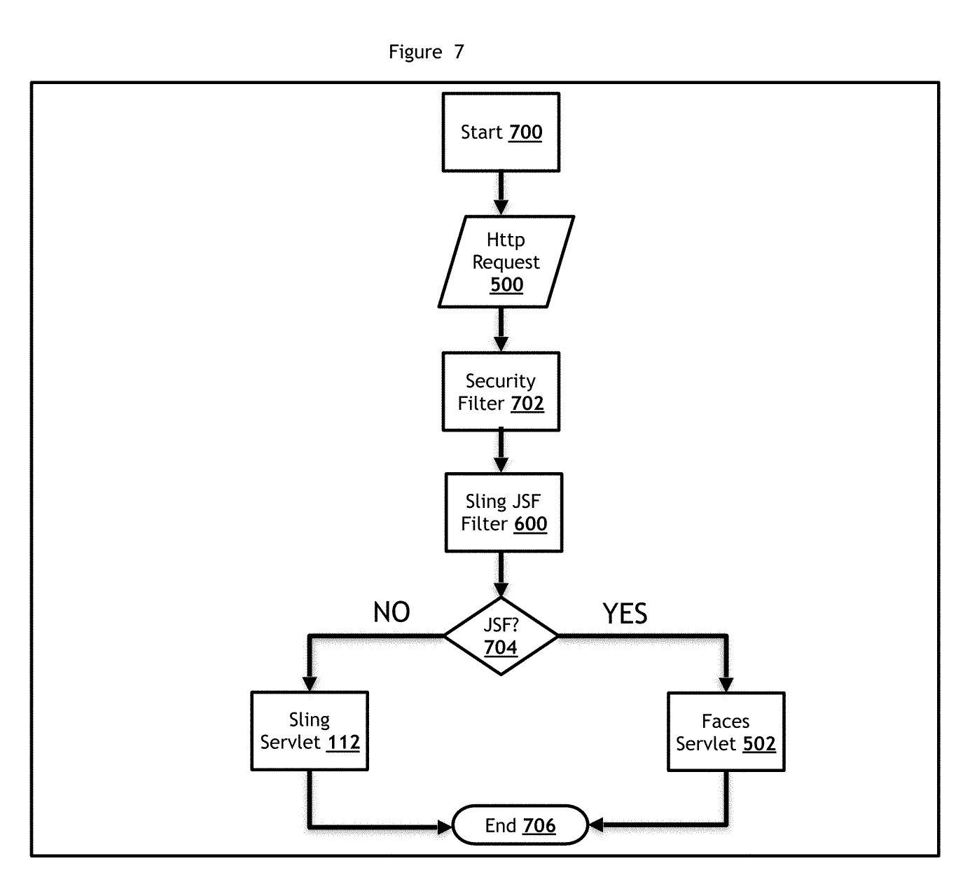

The security frame work provided by Apache Sling Web Framework is not viable for building Java J2EE grade enterprise applications. One can choose security frameworks such as Apache Shiro Security Framework, Spring Security Framework, Identity and Access Management Frameworks or Object Access Control (OACC) java security framework. This is shown in Security Filter in the following FIG. 7.

In order for Sling Web Framework to support Java/J2EE functionality, the following modifications have been made to the Web deployment descriptor 402 as described in FIG. 7 Description of Web Deployment Descriptor as follows.

All the Http Requests 500 will pass though the Security Filter 702. After passing though Security Filter, Http Requests will pass through the Sling JSF Filter 600 as described in FIG. 6. After passing though Sling JSF Filter, Http Requests passes through the control logic, if the Http Request is for Java Server Faces (JSF) pages, request will be served by the Faces Servlet 502 otherwise it will be served by the Sling Servlet 112.

At present Apache Sling Web Framework is specifically rendering Java Server Page (.jsp) files, but when rendering JSF components, this restriction of rendering only JSP files needs to be removed from the Sling Servlet in service method. To render Felix web console 136 and System console following method changes need to be performed on a HttpRequest, for pathInfo, HttpRequestURI and HttpRequestURL.

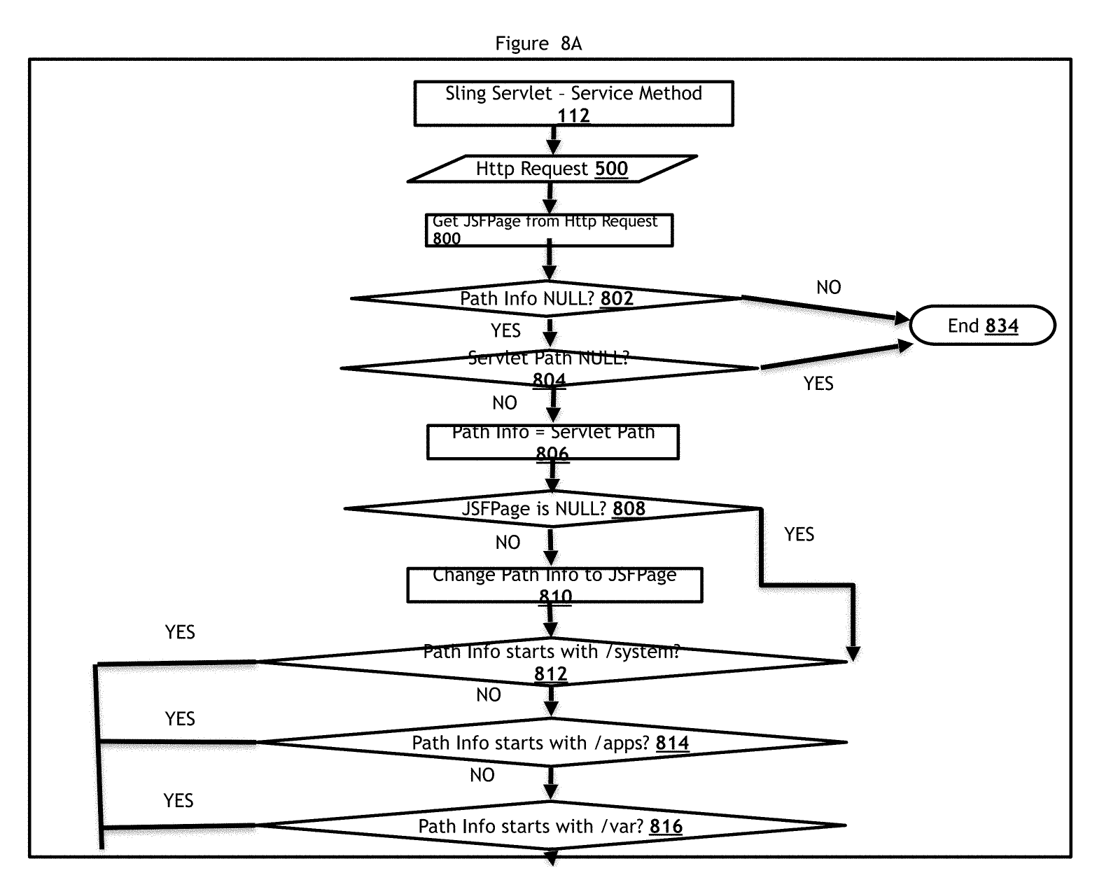

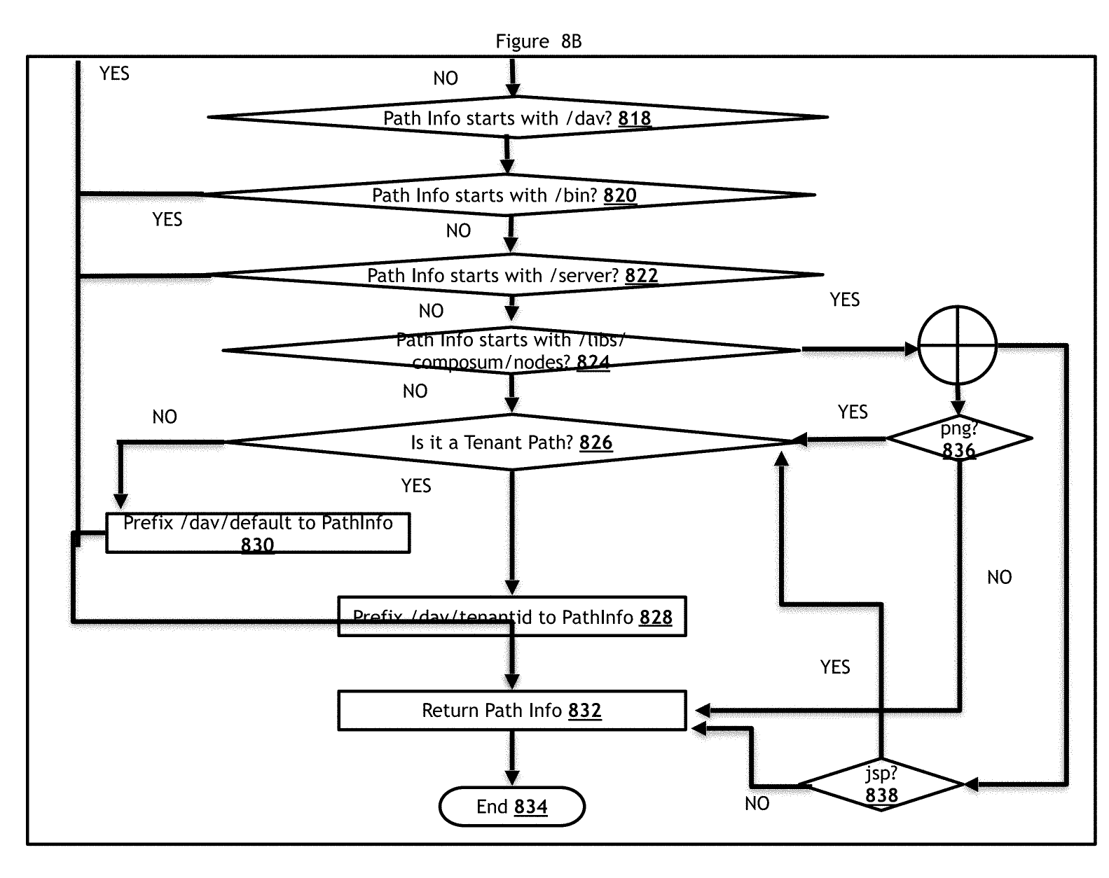

FIG. 8 illustrates the process flow for Sling Servlet path info in the service method and is described below.
112 Sling Servlet Service Method
500 Sling Servlet Service Method takes Http Request
800 Get JSFPage from Http Request
802 Get Path Info from Http Request
   If Path Info is not NULL end the process 834
   If Path Info is NULL go to 804
804 Get Servlet Path from Http Request
   If Servlet Path is NULL end the process 834
   If Servlet Path is not NULL go to 806
806 Set Path Info to Servlet Path
808 Is JSF Page NULL?
   If JSF Page is NULL go to 812
   If JSF Page is not NULL go to 810
810 Change path Info to JSFPage
812 is Path Info starts with /system?
   If it is true return Path Info 832 and end the process 834
   If it is false go to 814
814 is Path Info starts with /apps?
   If it is true return Path Info 832 and end the process 834
   If it is false go to 816
816 is Path Info starts with /var?
   If it is true return Path Info 832 and end the process 834
   If it is false go to 818
818 is Path Info starts with /dav?
   If it is true return Path Info 832 and end the process 834
   If it is false go to 820
820 is Path Info starts with /bin?
   If it is true return Path Info 832 and end the process 834
   If it is false go to 822
822 is Path Info starts with /server?
   If it is true return Path Info 832 and end the process 834
   If it is false go to 824
824 is Path Info starts with /libs/composum/nodes?
   If it is true go to 836 or 838
   If it is false go to 826
826 is Path Info is Tenant Path?
   If it is true go to 828
   If it is false go to 830
828 Prefix /dav/tenantid to Path Info and go to 832
830 Prefix /dav/default to Path Info and go to 832
832 return Path Info and go to 834
836 is Path Info a png file?
   If it is true go to 826
   If it is false go to 832
838 is Path Info a jsp file?
   If it is true go to 826
   If it is false go to 832
834 end process

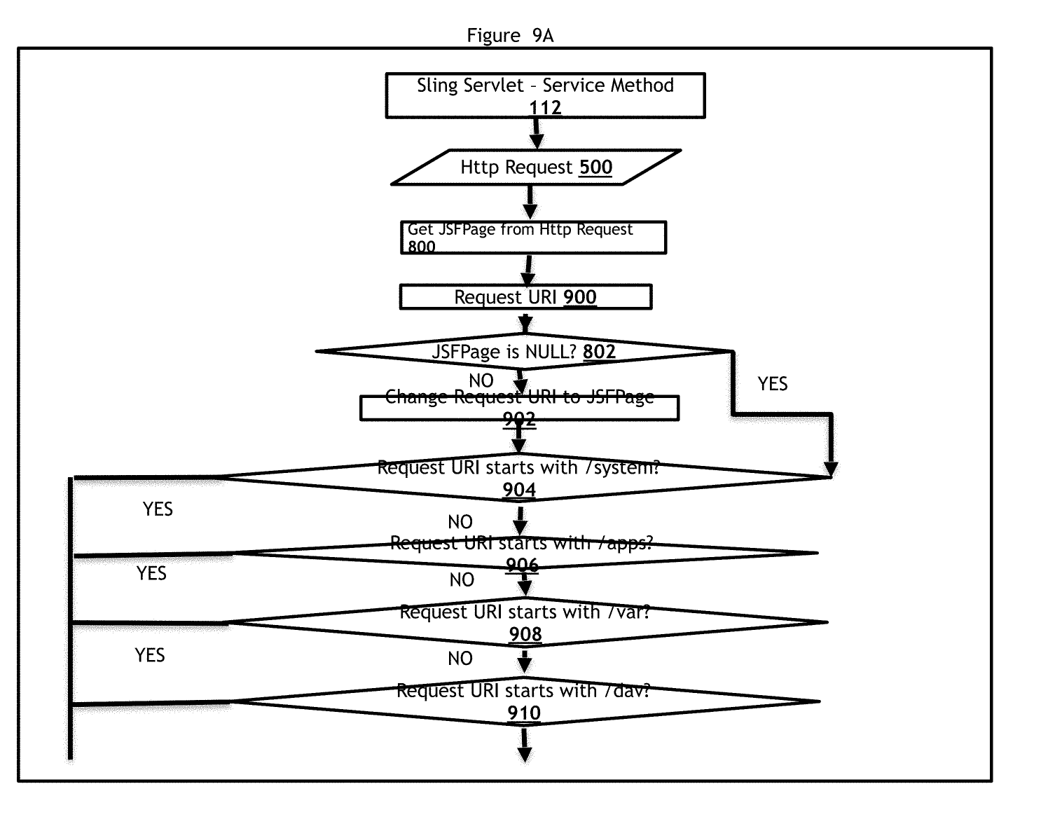

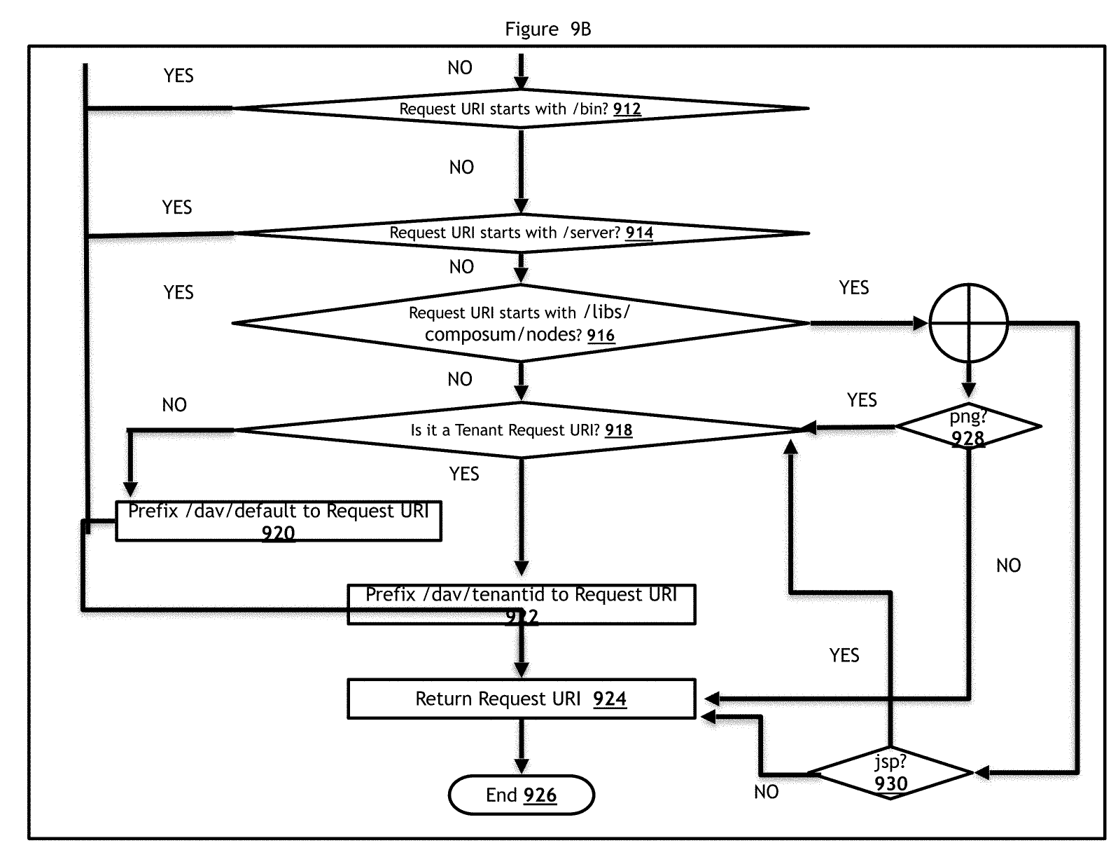

FIG. 9 illustrates the process flow for Sling Servlet Request URI in the service method. This process is further described below.
112 Sling Servlet Service Method
500 Sling Servlet Service Method takes Http Request
800 Get JSFPage from Http Request
900 Get Request URI from Http Request
802 Is JSF Page NULL?
   If JSF Page is NULL go to 904
   If JSF Page is not NULL go to 902
902 Change Request URI to JSFPage
904 is Request URI starts with /system?
   If it is true return Request URI 924 and end the process 926
   If it is false go to 906
906 is Request URI starts with /apps?
   If it is true return Request URI 924 and end the process 926
   If it is false go to 908
908 is Request URI starts with /var?
   If it is true return Request URI 924 and end the process 926
   If it is false go to 910
910 is Request URI starts with /dav?
   If it is true return Request URI 924 and end the process 926
   If it is false go to 912
912 is Request URI starts with /bin?
   If it is true return Request URI 924 and end the process 926
   If it is false go to 914
914 is Request URI starts with /server?
   If it is true return Request URI 924 and end the process 926
   If it is false go to 916
916 is Request URI starts with /libs/composum/nodes?
   If it is true go to 928 or 930
   If it is false go to 924
918 is Request URI is a Tenant Path?
   If it is true go to 922
   If it is false go to 920
922 Prefix /dav/tenantid to Request URI and go to 924
920 Prefix /dav/default to Request URI and go to 924
924 return Request URI and go to 926
928 is Request URI a png file?
   If it is true go to 918
   If it is false go to 924
930 is Request URI a jsp file?
   If it is true go to 918
   If it is false go to 924
926 end process

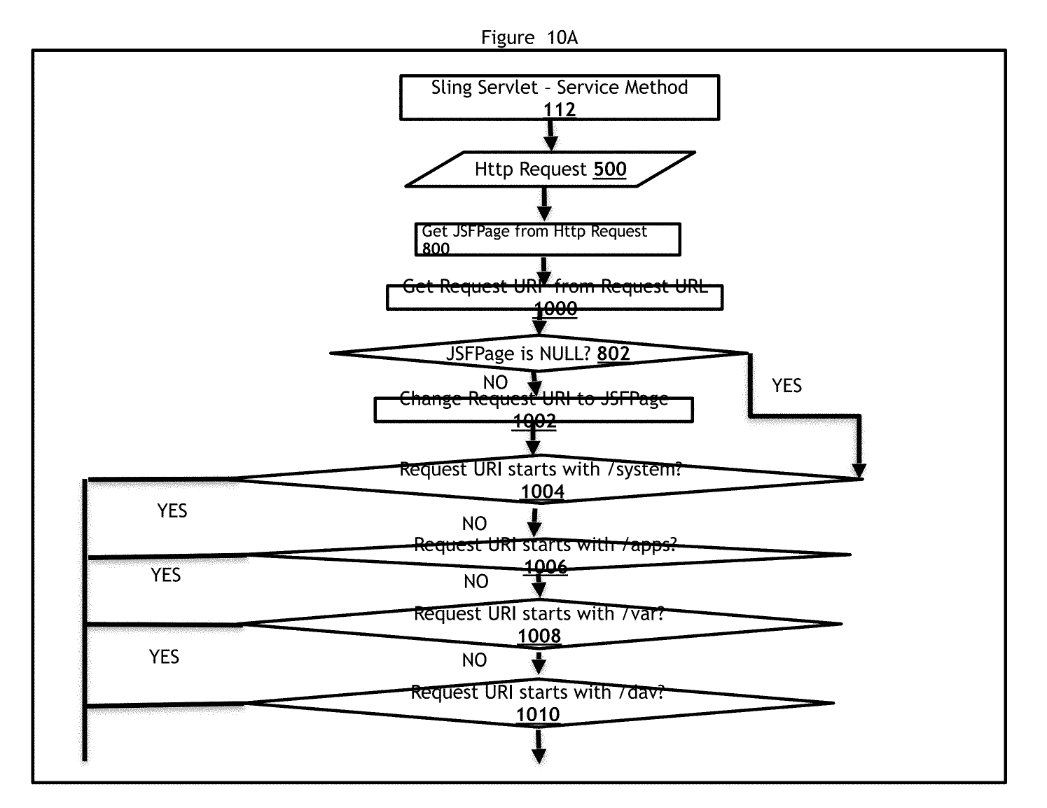

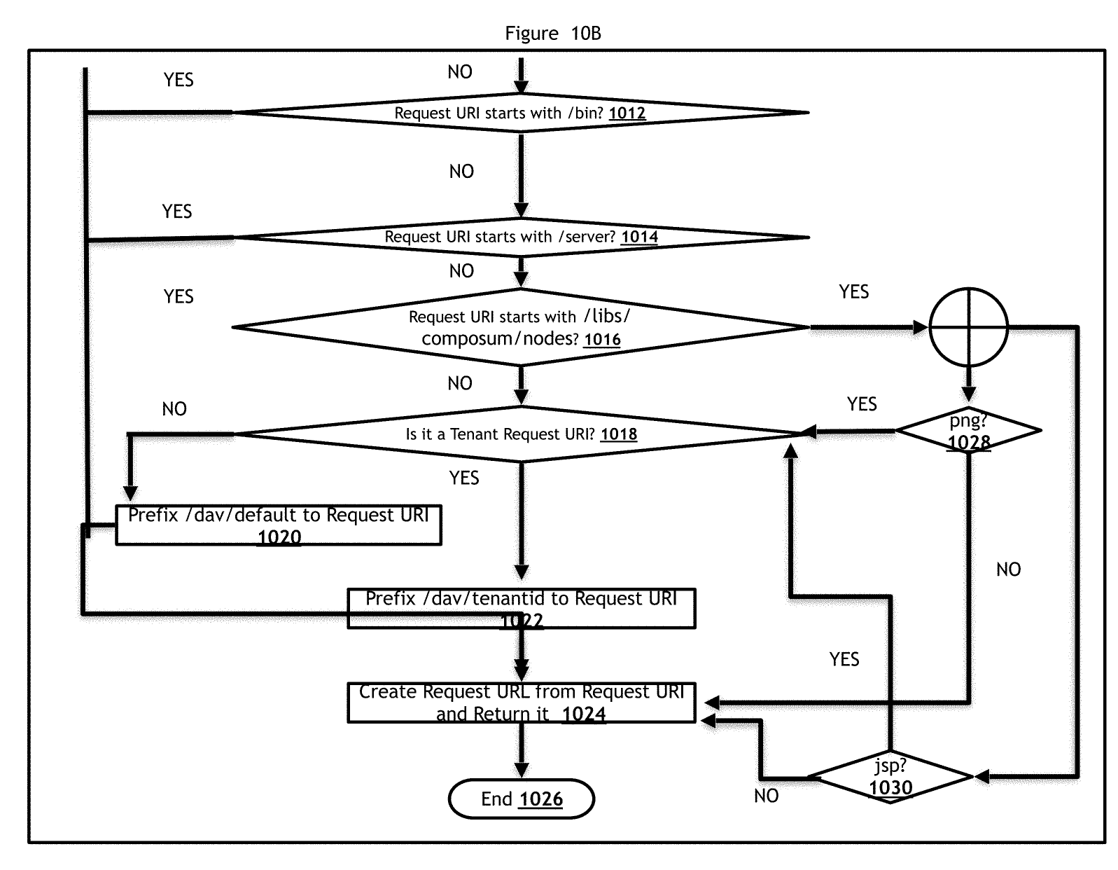

FIG. 10 illustrates a process flow for Sling Servlet Request URL in the service method. This process is further described below.
112 Sling Servlet Service Method
500 Sling Servlet Service Method takes Http Request
800 Get JSFPage from Http Request
1000 Get Request URL from Http Request and retrieve Request URI from Request URL
802 Is JSF Page NULL?
   If JSF Page is NULL go to 1004
   If JSF Page is not NULL go to 1002
1002 Change Request URI to JSFPage
1004 is Request URI starts with /system?
   If it is true return Request URI 1024 and end the process 1026
   If it is false go to 1006
1006 is Request URI starts with /apps?
   If it is true return Request URI 1024 and end the process 1026
   If it is false go to 1008
1008 is Request URI starts with /var?
   If it is true return Request URI 1024 and end the process 1026
   If it is false go to 1010
1010 is Request URI starts with /var?
   If it is true return Request URI 1024 and end the process 1026
   If it is false go to 1012
1012 is Request URI starts with /bin?
   If it is true return Request URI 1024 and end the process 1026
   If it is false go to 1014
1014 is Request URI starts with /server?
   If it is true return Request URI 1024 and end the process 1026
   If it is false go to 1016
1016 is Request URI starts with /libs/composum/nodes?
   If it is true go to 1028 or 1030
   If it is false go to 1024
1018 is Request URI is a Tenant Path?
   If it is true go to 1022
   If it is false go to 1020
1022 Prefix /dav/tenantid to Request URI and go to 1024
1020 Prefix /day/default to Request URI and go to 1024
1024 Create Request URL from Request URI and return it and go to 1026
1028 is Request URI a png file?
   If it is true go to 1018
   If it is false go to 1024
1030 is Request URI a jsp file?
   If it is true go to 1018
   If it is false go to 1024
1026 end process

Spring Framework, EJB and other J2EE middleware frameworks need to be copied into WEB-INF/lib for providing J2EE functionality to the Apache Sling Framework.

After making these changes to Apache Sling implementation, appropriate build commands are used to generate war file based on project specific requirements. The generated war file will be placed at root directory of application or web server as ROOT,war along with required Identity and Access Management deployments, database configurations and No SQL MongoDB or Flat File installation.

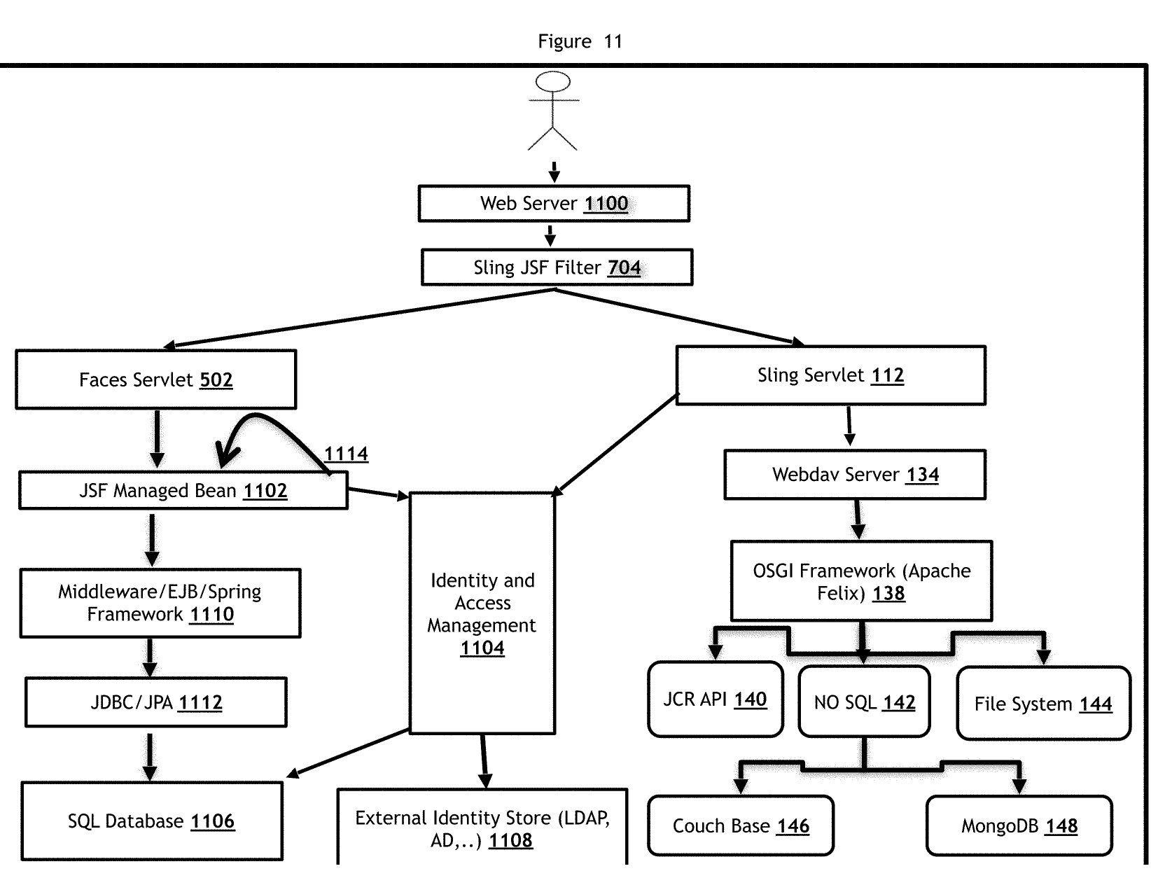

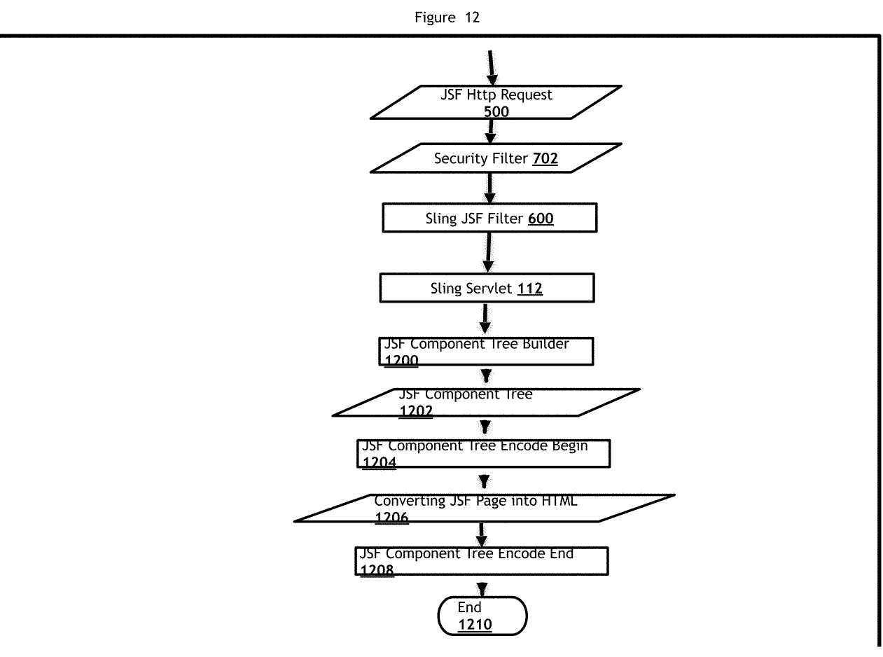

FIG. 11 illustrates the incorporation of JSF servlet and Sling servlet into Apache Sling web application. This process is further described below.
1100 User requests JSF Page
704 User Http Request Passes through Sling JSF Filter and if the content is from content management system. Sling JSF Filter mechanism is explained in FIG. 7.
502 Based on jsf extension (.xhtml) from web deployment descriptor will send request to the JSF Faces Servlet
1102 JSF Faces Servlet invokes corresponding JSF Managed Bean.
1104 JSF Managed Bean checkup with Identity and Access Management for Authentication and Authorization roles.
1106 Identity and Access Management framework may connect to SQL Database for Authentication and Authorization roles verification.
1108 Identity and Access Management framework may connect to External Identity Store (Active Directory or LDAP) for Authentication and Authorization roles verification.
1110 After successful IAM check, JSF Managed Bean may use Middleware for business functionality rules or access external systems.
1112 Middleware may use JDBC/JPA framework for accessing data.
1106 JDBC/JPA framework will retrieve data from the database.
112 If user requests for any content which is not a JSF file extension (.xhtml), web deployment descriptor will forward request to the Sling Servlet.
1104 Sling Servlet will do Identity and Access Management Check for authentication and authorization access level and which in turn follows steps 1106 and 1108.
134 After Identity and Access Management check, Sling Servlet will request content from Webdav Server.
138 Webdav Server uses Apache Felix OSGI Framework and JCR API 140 for retrieving content from NOSQL 142 (Couch Base 146 or MongoDB 148) databases or from file System 144.
1114 JSF Managed Bean receives JSF content from Sling Servlet for Content Management System based JSF Files. These JSF cannot be rendered on webpage without concerting them to HTML page. This mechanism explained in FIG. 12.

FIG. 12 illustrates conversion of JSF code using JSF Tree Component Builder and encoding them to HTML code for display. This process is further described below.
500 JSF Http Request
702 JSF Http Request passes through the Security Filter
600 JSF Http Request passes though the Sling JSF Filter and mechanism explained in Sling JSF Filter section
112 After passing though the Sling JSF Filter, Http Request will go to Sling Servlet and retrieves content from content management system.
1200 JSF page raw content is passed though the JSF Component Tree Builder. JSF Component Tree Builder parses JSF raw content and creates corresponding UIComponent and arranges as Component Tree structure.
1202 JSF Component Tree is same structure as HTML Tree elements and which can be converted to HTML as follows.
1204 JSF Component Tree Encode Begin—Which starts conversion of JSF tags to HTML tags.
1206 Converting JSF Page into HTML.
1208 JSF Component Tree Encode End—Which ends conversion of JSF tags to HTML tags.
1210 process end

For the purposes of clarity, and in summary of the invention described herein, numbers embodiments are described. In an embodiment of the present invention, a content management system or enterprise application are built using Sling Servlet (org.apache.sling.launchpad.webapp.SlingServlet) and Faces Servlet (javax.faces.webapp.FacesServlet) specified in web.xml running on a web server.

In an embodiment of the present invention, Apache Sling web framework is extended into Java/J2EE Web and Application servers without impacting presently existing functionalities.

In an embodiment of the present invention, Apache Sling Web Framework is extended to support Open Source Spring Framework, EJB and Service Oriented Architecture (SOA) middleware frameworks.

In an embodiment of the present invention, Apache Sling Web Framework is extended to render content in component based Java Server Faces (JSF) views.

In an embodiment of the present invention, Apache Sling Web Framework is extended to create exclusively JSF based Content Management System without using JSF bridge or JSF portlet bridge.

In an embodiment of the present invention, Apache Sling Web Framework is extended to develop on premise and cloud based enterprise applications.

In an embodiment of the present invention, Apache Sling Web Framework is extended to have Java EE compliance and having Create, Read, Update and Delete operations to Java Server Faces Pages performed on the Content Management System using one or more RESTFul Web Services in single Web or the Application Server through CURL interface.

In an embodiment of the present invention, Apache Sling Web Framework is extended to have Java EE compliance and having Create, Read, Update and Delete operations to Java Server Faces Pages performed on the Content Management System using one or more RESTFul Web Services in single Web or the Application Server through Http Client application interface.

In an embodiment of the present invention, Apache Sling Web Framework is extended to have Java EE compliance and having Create, Read, Update and Delete operations to Java Server Faces Pages performed on the Content Management System using one or more RESTFul Web Services in single Web or the Application Server through Web interface.

In an embodiment of the present invention, Apache Sling Web Framework is extended with Identity and Access Management to secure content and give content method level access.

In an embodiment of the present invention, Apache Sling Web Framework is extended with Identity and Access Management for secure tenant level content management system.

In an embodiment of the present invention, Apache Sling Web Framework is extended with any of the Java Server Primefaces, ICEfaces, Richfaces, Apache My Faces, Oracle ADF, Open Faces JSF, IBM XPages, Omni Faces, Butter Faces, Boots Faces, Liferay Faces, GIS Faces, High Faces and Tie Faces and ZK Faces.

In an embodiment of the present invention, Apache Sling Web Framework is extended with JSF and used as a basis for any Java/J2EE enterprise applications which are not limited to Enterprise Resource Planning (ERP), Enterprise Business Solutions (EBS), Human Capital Management (HCM), Enterprise Financial Applications, Enterprise Health Care Applications, Supply Chain Management, Block Chain Applications and any other Java/J2EE Enterprise custom applications.

In an embodiment of the present invention, Apache Jack Rabbit based Hippo CMS, eXO JCR, Jahia, LogicalDOC, Magnolia CMS, Open KM, Sakai Project and Adobe AEM content management systems and future implementations of content management systems with extending functionality of supporting Java Server Faces framework using Apache Sling Web Framework.

In an embodiment of the present invention, Apache Sling Web Framework is extended with JSF functionality and Content Repository Java API (JCR) can be placed on content distribution network (CDN) to provide high availability and high performance.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiment disclosed herein, but instead as being fully commensurate in scope with the spirit of the invention throughout the description.

1. A content management system having Apache Sling Web Framework compromising:
a. a memory device; and
b. a processor, wherein the processor performs the steps of creating, reading, updating and deleting content including Java Server Faces pages stored in a memory device,
wherein the Content Management System accepts a framework into a Java EE compliance framework, wherein the framework builds one or more Java EE Architecture applications, wherein each of the one or more Java EE Architecture applications has functionalities of a plurality of Java EE Standard Services, or Java based Spring infrastructure framework tools, but do not any have any specific content management associated with the framework wherein each of the one or more Java EE Architecture framework applications can be extended with the content management system functionality in same web or application server using modified Apache Sling Web Framework, without affecting existing functionality.

2. The content management system of claim 1, wherein Apache Sling Web Framework web archive web deployment descriptor (or Web Servlet Specification) Sling Servlet override functionality converted into default servicing servlet means if no other servlet satisfies that request, Sling Servlet accepts that request in same web or application server to provide additional functionality to the web application framework.

3. The content management system of claim 1, wherein Apache Sling Web Framework web archive web deployment descriptor (or Web Servlet Specification) in addition to Sling Servlet and can in cooperate one or more other Servlets.

4. The content management system of claim 1, wherein modifications to the Apache Sling Web Framework to have Java EE compliance.

5. The content management system of claim 1, having Create, Read, Update and Delete operations to Java Server Faces Pages performed on the Content Management System using one or more RESTFul Web Services in single Web or the Application Server through CURL interface.

6. The content management system of claim 1, having Create, Read, Update and Delete operations to Java Server Faces Pages performed on the Content Management System using one or more RESTFul Web Services in single Web or the Application Server through Http Client application interface.

7. The content management system of claim 1, having Create, Read, Update and Delete operations to Java Server Faces Pages performed on the Content Management System using one or more RESTFul Web Services in single Web or the Application Server through Web interface.

8. The content management system of claim 1, wherein the modifications to the Apache Sling Web Framework to have Java EE compliance and to view the content management system files using WebDav interface in single Web or the Application Server.

9. The content management system of claim 1, wherein modifications to the Apache Sling Web Framework to have Java EE compliance and to view the content management system using Felix OSGI console in single Web or the Application Server.

10. The content management system of claim 1, wherein modifications to the Apache Sling Web Framework to have Java EE compliance and supporting OSGi framework specifications using Sling Management Console.

11. The content management system of claim 1, wherein modifications to the Apache Sling Web Framework to have Java EE compliance and to support Open Source Spring Framework in single Web or the Application Server.

12. The content management system of claim 1, wherein modifications to the Apache Sling Web Framework to have Java EE compliance selected from the group consisting of; Java EE Standard Services (HTTP, HTTPS, JTA, RMI-IIOP, Java IDL, JDBC API, Java Persistence API (JPA), Java Messaging System (JMS), Java Naming and Directory Interface (JNDI), Java Mail, JavaBeans Activation Framework (JAF), XML Processing (JAXP), Java EE Connector Architecture, Security Services, Web Services, Concurrency Utilities, Batch, Management, Deployment, Interoperability, Product Extensions, Platform Roles and Contracts, in single Web or the Application Server.

13. The content management system of claim 1, wherein modifications to the Apache Sling Web Framework to have Java EE compliance along with running in Enterprise Java Beans(EJB) container in the same Application Server.

14. The content management system of claim 1, wherein the modifications to the Apache Sling Web Framework to have Java EE compliance along with supporting Service Oriented Architecture (SOA) middleware framework in the same Application Server.

15. The content management system of claim 1, wherein the modifications to the Apache Sling Web Framework to have Java EE compliance along with accessing data from Relational Database in same Web or Application Server.

16. The content management system of claim 1, wherein the modifications to the Apache Sling Web Framework to have Java EE compliance along with no change in JSP, HTL and other scripting supporting functionality for content management system support in the same Web or the Application Server.

17. The content management system of claim 1, wherein the modifications to the Apache Sling Web Framework to have Java EE compliance along with displaying content using Java Server Faces without using JSF bridge or JSF Portlet bridge in the Web or the Application Server.

18. The content management system of claim 1, wherein the modifications to the Apache Sling Web Framework to have Java EE compliance along with a tenant level content management system in same Web or the Application server.

19. The content management system of claim 1, wherein the modifications to the Apache Sling Web Framework to have Java EE compliance and displaying content in any of the Java Server Faces Frameworks in the same Web or the Application server.
